(19) United States
(12) Patent Application Publication
(10) Pub. No.: US 2010/0157594 A1
(43) Pub. Date: Jun. 24, 2010

(54) LED LAMP

(75) Inventors: RI-LANG YANG, Shenzhen City (CN); GUANG YU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/477,115

(22) Filed: Jun. 2, 2009

(30) Foreign Application Priority Data
Dec. 23, 2008 (CN) 200810306479.6

(51) Int. Cl. F21V 1/00; F21S 4/00

(52) U.S. Cl. 362/235; 362/249.02

(57) ABSTRACT

An LED (light emitting diode) lamp includes a lamp body and a plurality of light emitting modules embedded in an outer surface of the lamp body. The outer surface of the lamp body is directed to different sides. Each light emitting module comprises a heat dissipating member and an LED module received in each light emitting module. The heat dissipating member includes a cylinder with an opening facing outwardly and a plurality of fins extending downwardly from a bottom of the cylinder into an inside of the lamp body.

### BACKGROUND

1. Technical Field

The disclosure relates to LED (light emitting diode) lamps and, more particularly, to an improved LED lamp capable of having a better management regarding heat dissipation of LEDs of the LED lamp.

2. Description of Related Art

An LED lamp utilizes LEDs as a source of illumination, in which current flowing in one direction through a junction region comprising two different semiconductors results in electrons and holes coupling at the junction region and generating a light beam. The LED is resistant to shock and has an almost endless lifetime under specific conditions, making it a popular, cost-effective and high quality replacement for incandescent and fluorescent lamps.

Known implementations of LED modules in an LED lamp make use of a plurality of individual LEDs to generate light that is ample and of satisfactory spatial distribution. The large number of LEDs, however, increases price and power consumption of the module. Considerable heat is also generated, which, if not adequately addressed at additional expense, impacts LED lamp reliability.

Furthermore, the LEDs are generally arranged on a printed circuit board which is attached to a flat outer surface of an individual heat sink. Conventionally, the heat sink comprises a spreader to whose one side the LED modules are attached and a plurality of fins arranged on another side of the spreader for dissipating heat generated by the LEDs into ambient. However, the LEDs attached to different places of the spreader of the heat sink are hard to be cooled at the same time or at the same degree, because of different places of the spreader having different quantity of the fins responsible for dissipating therefrom. Therefore, some LEDs may be cooled sufficiently and kept in a normal performance, but some LEDs would not be taken care equally, may be overheated and damaged.

What is needed, therefore, is an LED lamp which can overcome the limitations described.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED amp in accordance with an embodiment of the present disclosure.

FIG. 2 is an exploded view of the LED lamp of FIG. 1.

FIG. 3 is an inverted view of the LED lamp of FIG. 2.

FIG. 4 is an enlarged, exploded view of a light emitting module of the LED lamp in FIG. 2.

FIG. 5 is an inverted view of FIG. 4.

### DETAILED DESCRIPTION

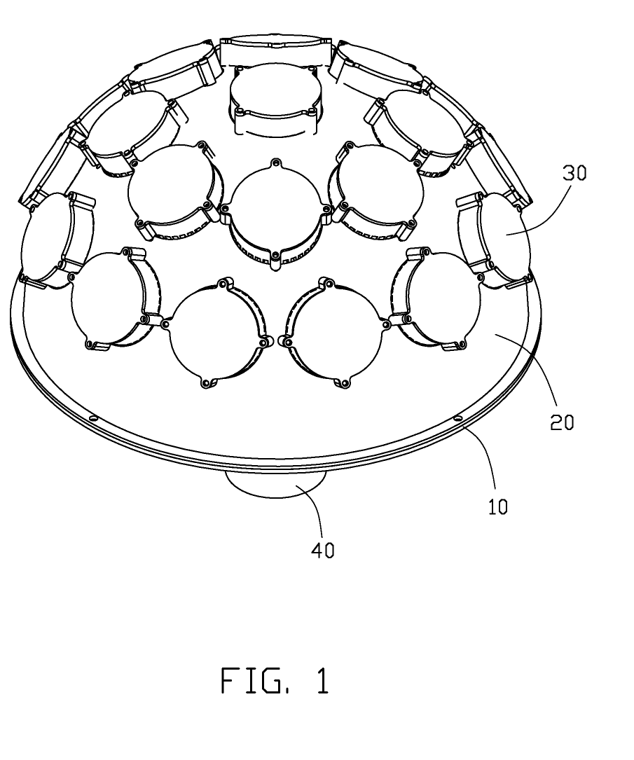

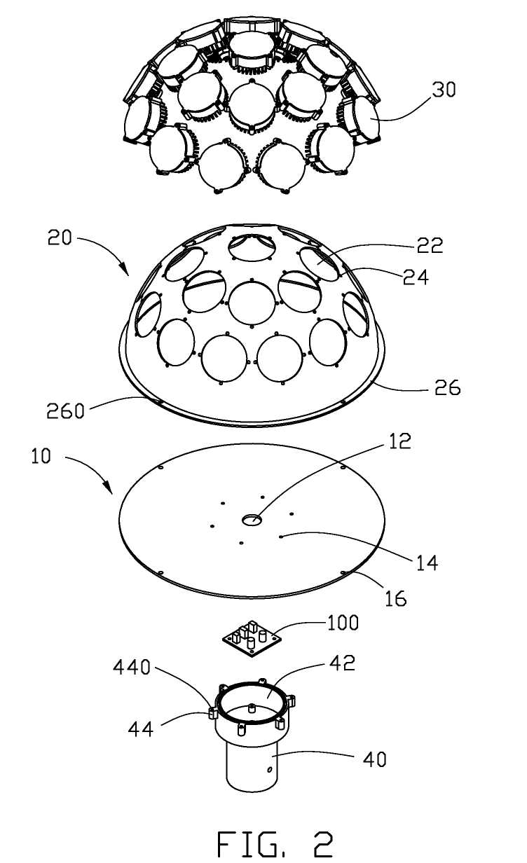

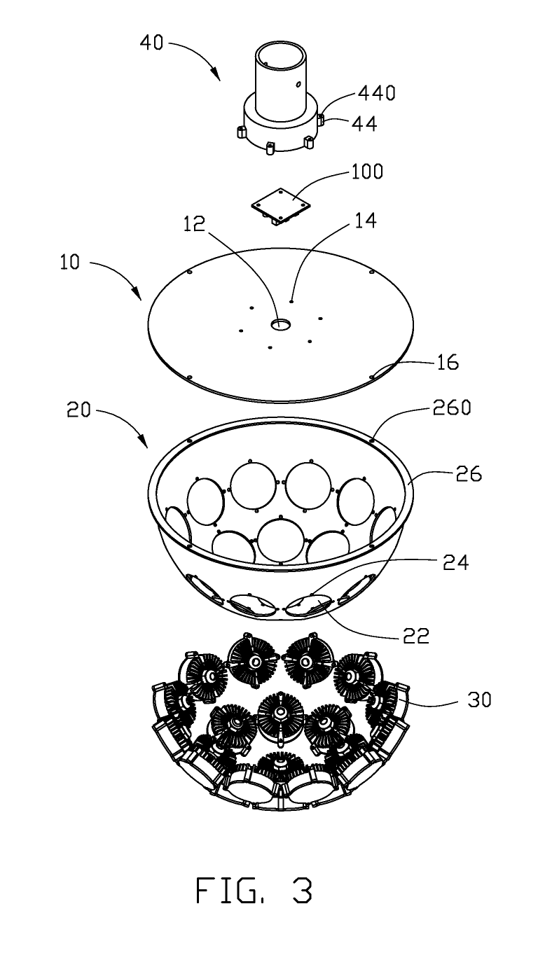

Referring to FIGS. 1-3, an LED (light emitting diode) lamp in accordance with an embodiment is illustrated. The LED lamp, which is configured for being held indoors or outdoor to provide illumination by a fixing pole (not shown), includes a covering plate 10, a lamp body 20 fixed on the covering plate 10, a plurality of light emitting modules 30 evenly mounted on an outer surface of the lamp body 20 and a fixing member 40 coupled to a bottom of the covering plate 10 to secure the LED lamp to the fixing pole.

The covering plate 10 is a circular thin plate and defines a through hole 12 in center thereof for allowing lead wire (not shown) to extend therethrough to electrically connect with the light emitting modules 30 and a driving and controlling circuit board 100 received in the fixing member 40. A plurality of fixing holes 14 surrounding the through hole 12 are defined in the covering plate 10 for screws (not shown) fixing the fixing member 40 onto the covering plate 10. A plurality of mounting holes 16 adjacent to an edge of the covering plate 10 are define in the covering plate 10 and centrosymmetrical relative to the through hole 12 for coupling the lamp body 20 and the covering plate 10 together.

The lamp body 20 is a hemisphere-shaped casing and has a circular opening facing the covering plate 10. The lamp body 20 defines a plurality of receiving holes 22 therein for respectively receiving the light emitting modules 30 therein. The receiving holes 22 are evenly distributed all over the hemisphere casing of the lamp body 20. The lamp body 20 defines a plurality group of mounting holes 24 therein. Each group of mounting holes 24 includes four mounting holes 24 which closely surround one of the receiving holes 22 for securing the light emitting module 30 in the corresponding receiving hole 22. An annular engaging flange 26 extends horizontally from an annular bottom edge of the lamp body 260 and defines a plurality of extending holes 260 therein. The annular engaging flange 26 has an outer diameter consistent with that of the covering plate 10; thus, the lamp body 260 can be fitly secured on a top surface of the covering plate 10 by screws (not shown) extending through the extending holes 260 of the lamp body 20 to be engagingly received in the corresponding mounting holes 16 of the covering plate 10. In other embodiments of the present disclosure, the lamp body 20 can be other configurations such as polyhedron-shaped, taper-shaped and any arch-shaped etc.

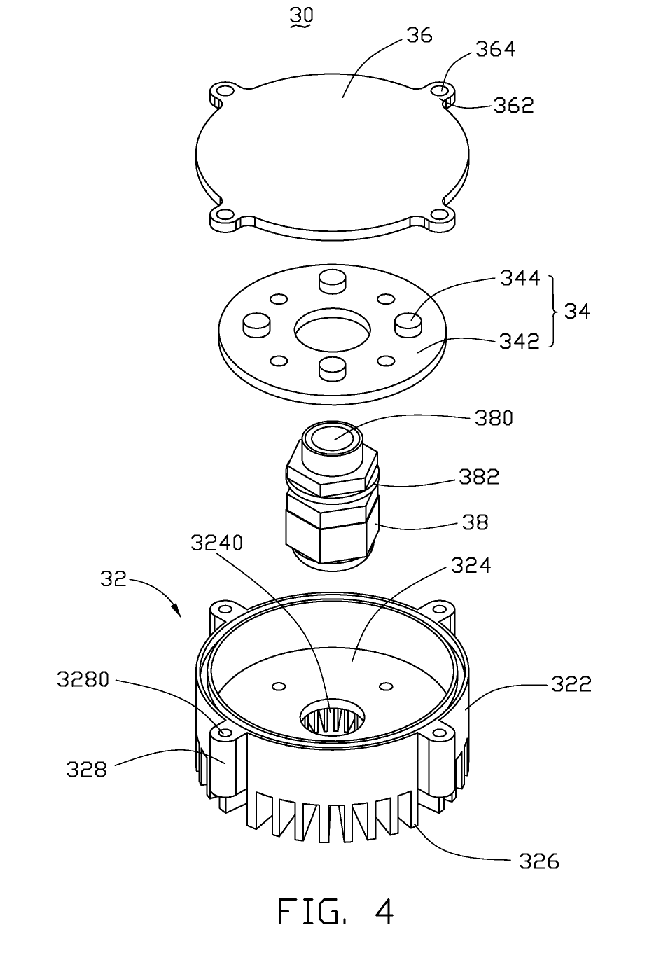

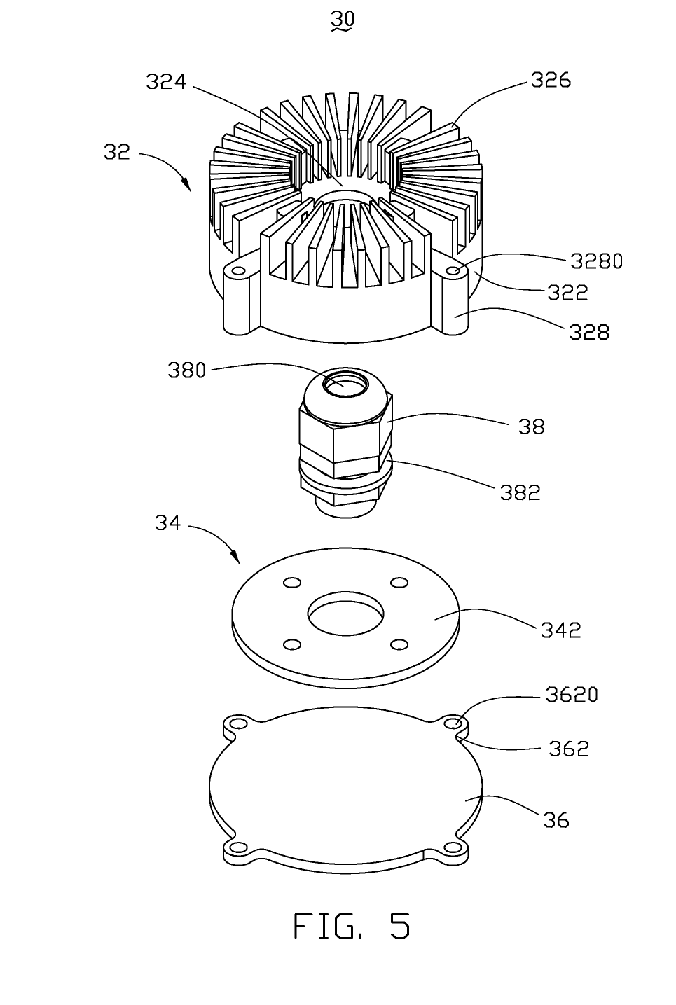

Also referring to FIGS. 4 and 5, each light emitting module 30 comprises a heat dissipating member 32, an LED module 34 mounted in an upper end of the heat dissipating member 32 and a lens 36 engaging with the upper end of the heat dissipating member 32 to enclose the LED module 34. The heat dissipating member 32 is integrally made of heat conductive material with high heat conductivity, such as copper or aluminum, and comprises a cylinder 322 opening upwardly, a partition board 324 formed at a bottom of the cylinder 322 and a plurality of fins extending perpendicularly from a bottom surface of the partition board 326. Four vertical, protruding posts 328 are symmetrically formed at a cylindrical surface of the cylinder 322. An engaging hole 3280 is defined through each protruding post 328 along its axis and corresponding to one of the mounting holes 24 of the lamp body 20. The partition board 324 is annular and has a piercing hole 3240 in the center thereof for the lead wire extending therethrough to electrically connect to the LED module 34. The fins 326 surrounding the piercing hole 3240 of the partition board 324 are arranged radially and outwardly from the piercing hole 3240 of the partition board 324 and centrosymmetrical relative to the piercing hole 3240. The heat dissipating members 32 are respectively received in the receiving holes 22 of the lamp body 20 with the fins 326 thereof passing through the receiving holes 22 to reach the inner side of the lamp body 20 and the protruding poles 328 thereof being rested on the outer surface of the lamp body 20 to hold the cylinders 322 thereof outside of the lamp body 20. A plurality of screws are extended through the mounting holes 24 of the lamp body 20 and engagingly received in the corresponding engaging holes 3280 in lower ends of the protruding posts 328 of the heat dissipating members 32 to thus securely hold the lighting emitting modules 30 in the receiving holes 22 of the lamp body 20.

Each LED module 34 comprises an annular printed circuit board 342 and a plurality of LED components 344 mounted on the printed circuit board 342. The annular printed circuit board 342 is received in the cylinder 322 and placed on the corresponding partition board 324. The lenses 36 are made of transparent/translucent plastic or glass. Each lens 36 is circular and engaged with a top end of the cylinder 322 to cover the opening of the cylinder 322. Each lens 36 has a plurality of retaining tabs 362 extending outwardly from a periphery edge thereof. Each retaining tab 362 defines a through orifice 364 therein for a screw extending therethrough to engage into the corresponding engaging hole 3280 in an upper end of the protruding post 328 of the heat dissipating member 32 to secure the lens 36 over the cylinder 322.

Each light emitting module 30 further includes a column-shaped joining member 38 received in the central piercing hole 3240 of the partition board 324 of the heat dissipating member 32 for enhancing airproof and waterproof capabilities. The joining member 38 is made of soft plastic and defines a hollow hole 380 therein for an extension of the lead wire therethrough. An annular recessing part 382 is defined in periphery surface of the joining member 30 and received in the piercing hole 3240 of the partition board 324 to securely hold the joining member 38 in place.

The fixing member 40 comprises two cylindrical parts with different outer diameters. An upper cylindrical part with a larger outer diameter defines a receiving room 42 therein for receiving the driving and controlling circuit board 100. A plurality of vertical retaining posts 44 are formed around the upper cylindrical part and each define a retaining hole 440 therein for engagingly receiving a screw extending through the fixing hole 14 of the covering plate 10 to couple the fixing member 40 to a center of a bottom of the covering plate 10. A lower cylinder part is connected to a bottom of the upper one and receives an end of the fixing pole therein to hole the LED lamp in a predetermined place.

In use of the LED lamp, the light emitting modules 30 are evenly embedded in a spherical outer surface of the lamp body 20, whereby light generated by the LED modules 34 of the light emitting modules 30 travels through the lenses 36 of light emitting modules 30 and is symmetrically directed to every angle surrounding the lamp. Since the light emitting modules 30 are independent and spaced from each other, heat generated by each LED module 34 is removed from the LED module 34 by an individual heat dissipating member 32; thus every LED module 34 is taken care equally and independently regarding its heat dissipation and would not be overheated and damaged accidently.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED (light emitting diode) lamp, comprising:
a lamp body having an outer surface directing to different sides; and
a plurality of light emitting (LED) modules embedded in the outer surface of the lamp body and each comprising a heat dissipating member having a cylinder with an opening facing outwardly and a plurality of fins extending downwardly from a bottom of the cylinder into an inside of the lamp body and a plurality of LED modules respectively received in the cylinders.

2. The LED lamp as claimed in claim 1, wherein the lamp body has a spherical outer surface through which the fins of the heat dissipating members are extended into the inside of the lamp body.

3. The LED lamp as claimed in claim 2, wherein the cylinders of the heat dissipating members are held outside of the lamp body and evenly distributed over the lamp body.

4. The LED lamp as claimed in claim 3, wherein a plurality of protruding posts are formed at a cylindrical surface of the cylinder and perpendicularly rested on the outer surface of the lamp body to hold the cylinder on an outside of the lamp body.

5. The LED lamp as claimed in claim 4, wherein each light emitting module further comprises a lens covering the opening of the cylinder and having plurality of retaining tabs extending outwardly from a periphery edge of the lens, the retaining tabs respectively engaged with top ends of the protruding posts of the heat dissipating member to fix the lens on a top of the cylinder.

6. The LED lamp as claimed in claim 1, wherein the heat dissipating member comprises a partition board which is formed at a bottom of the cylinder and defines a piercing hole in a center thereof.

7. The LED lamp as claimed in claim 6, wherein the fins surrounds the piercing hole of the partition board and are arranged radially and outwardly from the piercing hole of the partition board, a corresponding LED module being placed on a top surface of the partition board.

8. The LED lamp as claimed in claim 6, wherein each light emitting module comprises a joining member which defines an annular recessing part around the joining member and is received in the piercing hole of the partition board, the joining member defining a hollow hole therein for an extension of lead wire.

9. The LED lamp as claimed in claim 1, further comprising a covering plate engaging with a bottom of the lamp body and a fixing member connected to a bottom of the covering plate for fixing the LED lamp to an end of a fixing pole.

10. The LED lamp as claimed in claim 9, wherein the lamp body is a hemisphere-shaped casing and has an annular engaging flange extending outwardly from a bottom end thereof and engaging with an edge portion of the circular covering board.

11. An LED lamp, comprising:
a lamp body;
a heat dissipating member attached to the lamp body and having a cylinder with opening at an upper end thereof, a partition board formed at a bottom of the cylinder and a plurality of fins extending downwardly from a bottom surface of the partition board; and
an LED module received in the cylinder and paced on a top surface of the partition board.

12. The LED lamp as claimed in claim 11, wherein the partition board is annular and defines a piercing hole in a center thereof.

13. The LED lamp as claimed in claim 12, wherein the fins surrounds the piercing hole of the partition board and are arranged radially and outwardly from the piercing hole of the partition board.

14. The LED lamp as claimed in claim 12, wherein the LED module comprises an annular printed circuit board placed on a top surface of the partition board and a plurality of LED components mounted on the printed circuit board.

15. The LED lamp as claimed in claim 12, further comprising a joining member which is engagingly received in the piercing hole of the partition board and defines a hollow hole therein for an extension of lead wires.

16. The LED lamp as claimed in claim 11, wherein a plurality of protruding posts are formed at a cylindrical surface of the cylinder.

17. The LED lamp as claimed in claim 16, further comprising a lens covering the opening of the cylinder and having plurality of retaining tabs extending outwardly from a periphery edge of the lens, the retaining tabs respectively engaged with top ends of the protruding posts of the corresponding heat dissipating member to fix the lens on a top of the cylinder.
